(19) United States
(12) Patent Application Publication
(10) Pub. No.: US 2007/0288172 A1
(43) Pub. Date: Dec. 13, 2007

(54) Biomedical information modeling

(76) Inventors: David Benjamin Aronow, Waltham, MA (US); Mark Richard Cacciapouti, Auburn, MA (US); Gregg Richard Yost, Waltham, MA (US); Bonnie Lynne Zeigler, Andover, MA (US)

Correspondence Address: FISH & RICHARDSON PC, P.O. BOX 1022, MINNEAPOLIS, MN, 55440-1022, US

(21) Appl. No.: 11/450,524

(22) Filed: Jun. 9, 2006

(51) Int. Cl. G06F 19/00; G06F 17/30

(52) U.S. Cl. 702/19; 707/6

(57) ABSTRACT

Among other things, configuring an information collection/retrieval system includes receiving a data file structured to describe biological data, generating a first metadata representation of a first part of the data file, generating a first configuration file based on the first metadata representation; and configuring the information collection/retrieval system using the first configuration file.

### FIELD OF DISCLOSURE

This disclosure relates to informatics, and more particularly to biomedical informatics.

### BACKGROUND

Biomedical phenomena are often the subject of scientific inquiries. Such inquiries often produce data regarding various phenomena. Generally, a researcher strives to make conclusions about a particular biomedical phenomenon of interest to him. Often, the credibility of those conclusions depends on the amount or quality of the data available to the researcher. A researcher having insufficient data to make a credible conclusion about a biomedical phenomenon often finds it necessary either to experimentally obtain more data, or to search for pertinent data within the universe of data generated by others. Both experimentally obtaining data and searching for pertinent data can be time-consuming and expensive.

### SUMMARY

In general, in one aspect, configuring an information collection/retrieval system includes receiving a data file structured to describe biomedical data, generating a first metadata representation of a first part of the data file, generating a first configuration file based on the first metadata representation, and configuring the information collection/retrieval system using the first configuration file.

Implementations may include one or more of the following features. Receiving the data file comprises receiving a spreadsheet representation of the data file. Generating a first metadata representation includes generating a database representation of the first part of the data file, and generating the first metadata representation based on the database representation. Generating a database representation includes expressing the database representation in a structured query language. Generating the first metadata representation includes expressing the first metadata representation in a markup language. Configuring an information collection/retrieval system also includes selecting the markup language to be extensible markup language. Generating the first configuration file includes expressing the first configuration file in a markup language. Configuring an information collection/retrieval system also includes selecting the markup language to be extensible markup language.

Configuring an information collection/retrieval system also includes generating a database schema based on the data file, and wherein configuring the information collection/retrieval system also includes applying the database schema to a database. Configuring the information collection/retrieval system includes generating a user interface based on the data file. Configuring an information collection/retrieval system also includes generating a second metadata representation of a second part of the data file, generating a second configuration file based on the second metadata representation, and further configuring the information collection/retrieval system using the second configuration file. Configuring an information collection/retrieval system also includes checking at least one of the database representation, the metadata representation, and the configuration file for errors.

In general, in another aspect, an information collection/retrieval system includes a database having a structure based on a taxonomy file describing biomedical data, a first interface layer generated on the basis of the taxonomy file, the first interface layer being configured to receive data from a user, and a first processing layer in data communication with the first interface layer, the processing layer being generated based on the taxonomy file, the processing layer being configured to access the database.

Implementations may have one or more of the following features. The taxonomy file comprises proper subsets that are each capable of generating an interface layer and a processing layer, wherein the first interface layer and the first processing layer are generated based on a proper subset of the taxonomy file. The information collection/retrieval system also includes a second interface layer that is generated based on a second proper subset of the taxonomy file, the second interface layer for receiving commands from a second user, and a second processing layer in data communication with the second interface layer, the second processing layer being generated based on the second proper subset of the taxonomy file, the second processing layer for accessing the database. The biomedical data includes data describing three distinct disease groups.

Other aspects include other combinations of the features recited above and other features, expressed as methods, apparatus, systems, program products, and in other ways. Other features and advantages will be apparent from the description and from the claims.

### DESCRIPTION OF DRAWINGS

FIG. 1 is a schematic depiction of an information structure.

FIG. 2A is a schematic depiction of a data element taxonomy.

FIG. 2B is an example data element taxonomy.

FIG. 3 is an example terminology service record.

FIG. 4 is a schematic depiction of a generation toolkit.

FIG. 5 is a flowchart for using the generation toolkit.

FIGS. 6 and 7 are schematic depictions of an information collection/retrieval system.

### DETAILED DESCRIPTION

Researchers working in different laboratories each generate data. In the biomedical context, the data is often expressed or annotated in a way that is peculiar to the research group that generated the data. This tends to inhibit the identification, retrieval, comparison, and combination of data across different investigative settings. Modeling information as described below helps mitigate the differences in how different researchers express or annotate their data, and therefore facilitates the identification, retrieval, and analysis of data.

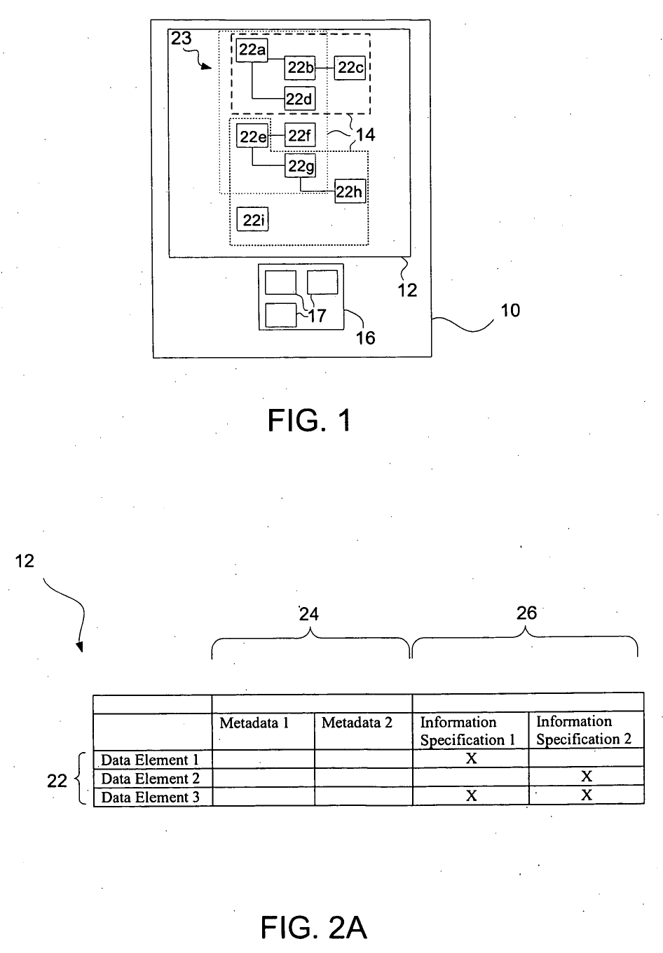

Referring to FIG. 1, an information structure 10 includes a data element taxonomy (“DET”) 12 and a terminology service 16. The data element taxonomy 12 is a structured list 23 of data elements 22 that are associated with various information specifications 14. In FIG. 1, the data elements 22 have been labeled 22a-i, and the data element taxonomy 12 is shown to include three information specifications 14, but in principle any number of data elements 22 or information specifications 14 may be used. Each information specification 14 is a “proper” subset of the data element taxonomy 12. As used herein, “proper” indicates that the data element taxonomy 12 includes more than just the data elements associated with a particular information specification 14.

Each information specification 14 contains a collection of selected data elements that are relevant to a particular biomedical setting. The setting can be as narrow or broad as desired. For example, one information specification 14 may correspond to studying cancer in general, while another may correspond to studying a particular type of cancer. Each information specification 14 serves as a data template for use by a researcher in the particular setting for recording or retrieving data.

The data element taxonomy 12, the information specifications 14, and the terminology service 16 are stored on an information storage medium such as a magnetic or optical disk, or on several such media in mutual data communication. The data element taxonomy 12 and the information specifications 14 can be represented as spreadsheets and can be created or modified using conventional software, for example Microsoft Excel. The terminology service 16 can be represented using a spreadsheet or using other known terminology development environments.

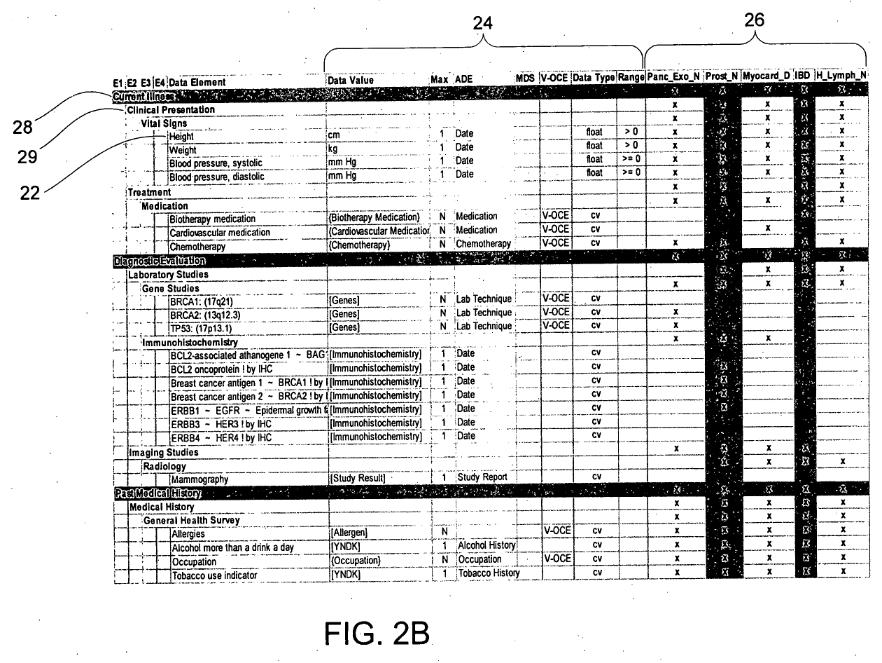

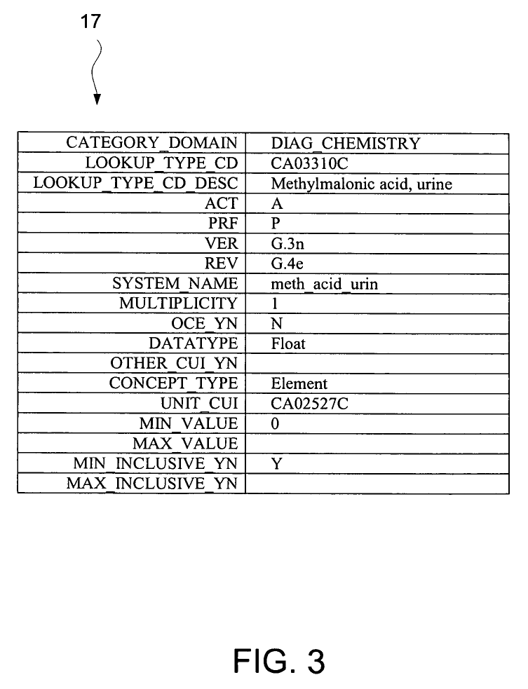

FIG. 2A shows a schematic data element taxonomy 12. This data element taxonomy 12 contains a list of data elements 22, corresponding metadata 24, and corresponding associations 26. The data elements 22 represent fields in which numerical values or other data may be placed. For a given data element 22, the corresponding metadata 24 specifies features of that data element 22. For example, if a data element 22 is “patient's height,” then the corresponding metadata 24 may include a specification that the data element is a numerical value and the units of measurement (e.g., centimeters) that the data element is measured in. The data elements 22 (and corresponding metadata 24) may be organized hierarchically in categories of any depth.

Within the data element taxonomy 12, associations 26 associate each data element 22 with one or more information specifications 14. In FIG. 2A, the data element taxonomy 12 is based on only two information specifications. Data Element 1 is associated with information specification 1, Data Element 2 is associated with information specification 2, and Data Element 3 is associated with both information specifications 1 and 2. For example, each of the information specifications may correspond to a different disease, with data elements 1 and 2 being indicative of symptoms peculiar to one disease but not the other, and data element 3 being relevant to the treatment of either disease.

Referring to FIG. 2B, the data elements 22 may be specified in a hierarchy. For example, they may be collected in categories 28 (e.g., current illness, diagnostic evaluation, past medical history), subcategories 29 (e.g., clinical presentation, treatment under the “current illness” category), and further-depth hierarchical collections (e.g., vital signs under “clinical presentation”).

In FIG. 2B, the metadata 24 includes: “data value,” which represents the form a particular value for a data element 22 can take; “max,” which indicates whether the data element 22 can take only a single value, or up to N values; “ADE” (for “ancillary data element”), which represents a pre-formed set of additional data elements to be displayed to the user in association with the data element 22; “MDS,” (for “minimum data set”), which is a description of what minimum amount of data must be supplied to constitute a valid record; “V-OCE,” (for “Value—Other Code Editor”), represents whether user-identified gaps in value sets can be recorded for the data element 22; “Data Type,” which indicates what type of data the data element 22 represents; “Range,” which indicates, for data elements 22 taking a numerical value, what the range of acceptable values are; and associations 26 of the various data elements 22 with the information specifications 14. This exemplary data element taxonomy 12 is based on five information specifications 14, as can be seen by counting the columns describing the associations 26. For example, the data element “chemotherapy” is associated with each information specification 14 except the “Myocard_D” information specification.

Referring back to FIG. 1, the terminology service 16 includes a set of concept records 17 pre-populated with concepts, relationships of a concept with other concepts, and metadata associated with the concept. A “concept” generally refers to any unit of thought related to clinical medicine that can be labeled with a name and a code, including, for example, data elements 22, categories 28, sub-categories 29, and further-depth hierarchical structures.

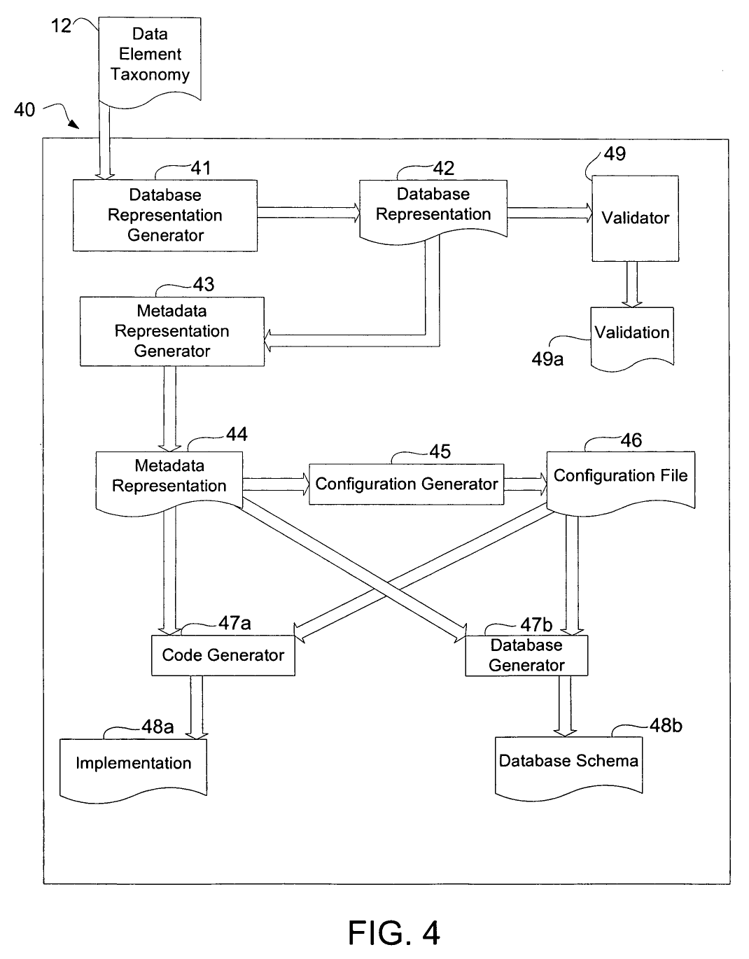

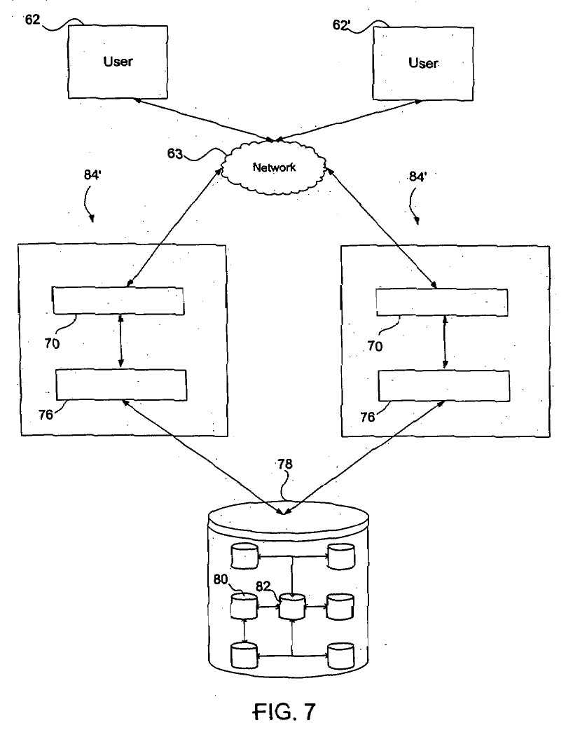

For example, FIG. 3 shows an exemplary terminology service record 17. In this example, the terminology service record 17 has the following fields: “CATEGORY DOMAIN,” which associates this entry with a particular subject matter area; “LOOKUP_TYPE_CD,” which is the electronic code for the concept represented in this terminology service record 17; LOOKUP_TYPE_CD_DESC”, which is the full English language name for the concept represented in this terminology service record 17; “ACT”, which is the activity status of the concept represented by this terminology service record 17; “PRF”, which is the preferred term status of the concept represented by this terminology service record 17; “VER”, which is the version number of the terminology service record 17 at which this concept record was first created; “REV”, which is the revision number of the terminology service record 17 at which this concept record was last revised; “SYSTEM_NAME”, which is a unique name for the concept represented by this terminology service record 17 that is used by electronic information systems, for example information collection/retrieval system 84 (see FIG. 6); “MULTIPLICITY”, which indicates the maximum number of valid values that can be associated with the concept represented by this terminology service record 17; “OCE_YN”, which indicates whether the Value—Other Code Edit feature is enabled for the concept; “DATATYPE”, which indicates the type of data of the data element 22 represented by this terminology service record 17; “OTHER_CUI_YN”, which indicates whether this concept serves the role of an Other concept unique identifier in association with the Value—Other Code Edit feature; “CONCEPT_TYPE”, which is the type of concept represented by this terminology service record 17; “UNIT_CUI”, which is the concept unique identifier for the dimensional units associated with the concept represented by this terminology service record 17; “MIN_VALUE”, which is the minimum value in the value range for the concept represented by this terminology service record 17; “MAX_VALUE”, which is the maximum value in the value range for the concept represented by this terminology service record 17; “MIN_INCLUSIVE_YN”, which indicates whether the minimum value in the value range for the concept represented by this terminology service record 17 is itself a permissible value; “MAX_INCLUSIVE_YN”, which indicates whether the maximum value in the value range for the concept represented by this terminology service record 17 is itself a permissible value;

The information structure 10 shown in FIG. 1 can be used to create an information collection/retrieval system 84 (see FIG. 6). Such a system 84 is generated based on the information structure 10 and is keyed to the particular informational needs of a client using that system 84. For example, researchers studying lung cancer need to record or retrieve data associated with lung cancer, and may not need to record or retrieve data associated with asthma.

Before generating the information collection/retrieval system 84, the information needs of the client are assessed. If the information needs of the client are conventional, then no modifications to the terminology service 16 or data element taxonomy 12 are required. For example, the client may be working in a biomedical context in which one or more pre-existing information specifications 14 adequately meet the client's informational needs. On the other hand, if the client's informational needs are unique, for example, if the client is investigating a correlation between two phenomena that has never before been examined, an existing information specification 14 may be modified, or new information specifications 14 may be developed. The terminology service 16 is typically modified as well.

Collecting and retrieving data using such a system 84 allows researchers in disparate investigative settings to effectively enter, store, locate and compare data. Because the information structure 10 essentially structures a researcher's data in a particular way, the data is quickly accessible to anyone else familiar with the information structure 10. By way of analogy, the information structure 10 provides a “mold” in which certain types of data “fit” into certain places in the mold. This encourages researchers to record or annotate data systematically, as opposed to idiosyncratically. Data that is recorded or annotated idiosyncratically by one researcher studying one problem may be difficult for another researcher studying another problem to even locate, let alone use. By encouraging the structured presentation and collection of data, the information structure 10 eases the burden of locating and sharing information.

Thus, a detailed and expansive information structure 10 (e.g., one with a relatively large number of information specifications 14) has relatively broad applicability to researchers in different investigative contexts. The exemplary data element taxonomy attached as Appendix A, includes three information specifications describing three disease groups: breast cancer, systemic infectious disease, and neurologic degenerative disease.

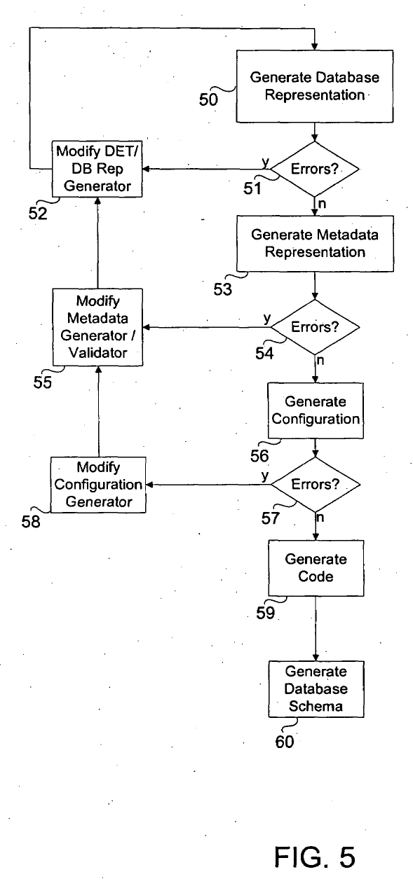

Referring to FIG. 4, the information structure 10 can be used by a generation toolkit 40 to create infrastructure for an information collection/retrieval system 84 (see FIG. 6). The generation toolkit 40 includes a database representation generator 41, a metadata representation generator 43, a configuration generator 45, a code generator 47a, a database generator 47b, and a validator 49. The generation toolkit 40 and each of its components may be hardware, software, or a combination of hardware and software. For example, they may be instructions contained in an information storage medium such as a magnetic or optical disk, a microprocessor programmed to perform the steps described below, combinations of those, or other examples.

The generation toolkit 40 uses the components of the information model 10 to implement an information collection/retrieval system 84 (see FIG. 6). The database representation generator 41 includes a module for producing, on the basis of the data element taxonomy 12, a database representation 42 of the data element taxonomy 12. The database representation 42 includes a description of each of the categories 28, sub-categories 29, further-depth categories, and data elements 22, as well as their associated metadata 24. In some implementations, the database representation 42 is expressed in a structured query language.

The metadata representation generator 43 includes a module for producing a metadata representation 44 of the data element taxonomy 12, based on the database representation 44. In some implementations, the metadata representation 44 is created directly from the data element taxonomy 12 or from a representation of the data element taxonomy 12 other than the database representation 42. The metadata representation 44 includes a description of each of the categories 28, sub-categories 29, further-depth categories, and data elements 22, as well as their associated metadata 24. In some implementations, the metadata representation 44 is expressed in a markup language, for example extensible markup language (“XML”).

The configuration generator 45 includes a module for producing a configuration file 46 for the information collection/retrieval system 84 based on the metadata representation 44. The configuration file 46 includes information for creating an interface through which a user may input or retrieve data values for those data elements 22 in the information specification 14 relevant to the user's informational needs. In some implementations, the configuration file 46 is expressed in XML.

The code generator 47a includes a module for producing, on the basis of the metadata representation 44 and the configuration file 46, an implementation 48a of the interface and infrastructure for the information collection/retrieval system 84. The implementation 48a includes modules to receive and process requests from a user to access the database 78 (see FIG. 6). In some implementations, these modules may include XML files, Struts forms, Java objects, or other software implementations.

The database generator 47b includes a module for producing, based on the configuration file 46 and the metadata representation 44, a database schema 48b for structuring the database 78 according to the data element taxonomy 12.

The validator 49 includes modules that performs error checking on the inputs of the various generation toolkit 40 components. The validator 49 performs syntactic checks (such as parsing the various files produced in the generation toolkit 40), logical checks (such as verifying that each data element 22 is used in at least one information specification 14), and other appropriate checks related to automated file generation. The validator 49 produces output in the form of a validation 49a. The validation 49a may be a log file, or other electronic representation of whether the input contains errors. In some embodiments, the validation 49a identifies the particular types of errors that occurred, and where they occurred in the input file.

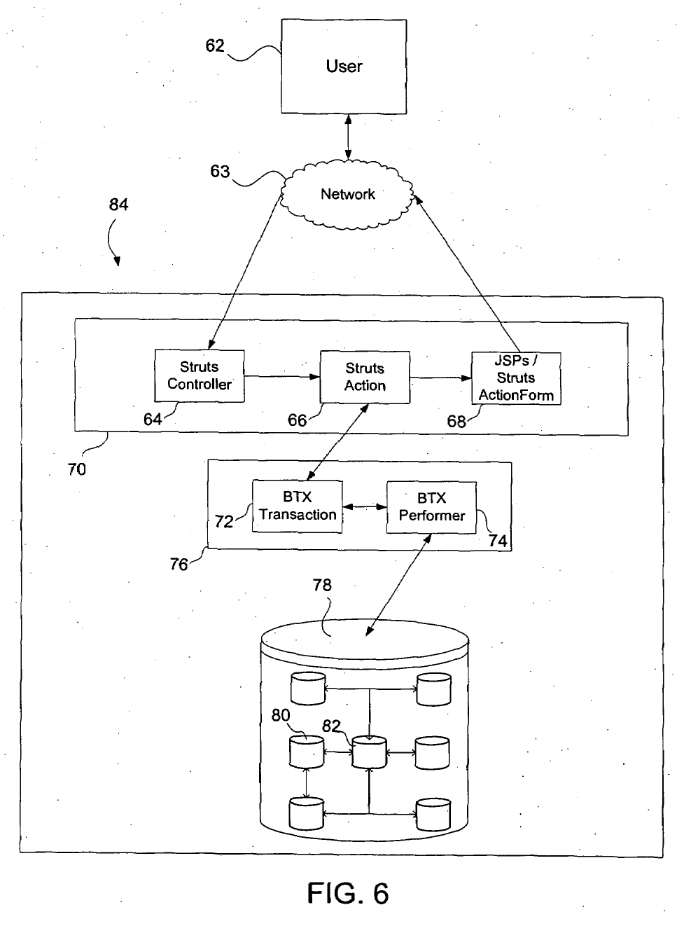

In FIG. 5, the data element taxonomy 12 is first used to create a database representation 42 of the data element taxonomy 12 (step 50). The database representation 42 populates a database 78 with metadata (see FIG. 6). After this step, database representation 42 is passed to the validator 49 to check for errors (step 51). Examples of errors include: errors in syntax, such as non-parseable lines; logical errors such an the absence of an association between a data element 22 and any information specification 14, or the absence of an association between an information specification 14 and any data element 22; or other common errors that are conventionally detectable. If there are errors in any of the terminology service 16, the data element taxonomy 12, and/or the database representation 42, then the files that cause the error are modified to correct the errors (step 52).

If there are no errors, the database representation 42 is passed to the metadata representation generator 43, which produces a metadata representation 44 of the data element taxonomy 12 (step 53). The metadata representation 44 encodes the data elements 22 and metadata 24 in the data element taxonomy 12. After this step, the output is passed to the validator 49 to check for errors (step 54). If there are errors generating the metadata representation 44, then the terminology service 16, the data element taxonomy 12, and/or the database representation 42 may be modified to correct the errors. Additionally, the validator 49 or the metadata representation generator 43 is/are modified to correct errors, if any such errors exist (step 55). If no such errors exist, the metadata representation generator 43 or the database generator 41 may be modified (step 52).

If there are no errors discovered in step 54, the metadata representation 44 is passed to the configuration generator 45, which then produces a configuration file (step 56). The configuration file contains metadata that dictates which data elements 22 in the data element taxonomy 12 are to be used to form database tables that are ultimately provided to a user.

After this step, the output is passed to the validator 49 to check for errors (step 57). If errors are discovered, the configuration generator 45 may be modified to correct the errors (step 58), as well as previously described error-correction modifications (steps 55, 52).

The configuration file 46 and the metadata representation 44 are passed to the code generator 47a (step 59) and the database generator 47b (step 60). The code generator 47a produces files 48a for implementing an application through which a user can interact with the information collection/retrieval system 84 (e.g., business rules specified in the data element taxonomy 12, Java classes supporting transactions among components of the system, etc.). The database generator 47b produces a database schema 48b that is applied to a database 78 (see FIG. 6) for storing data entered by the user.

In FIG. 6, an information collection/retrieval system 84 includes an interface layer 70, a processing layer 76, and a database 78, all of which are in mutual data communication. A user 62 engages the system 84 in data communication through the interface layer 70. Data communication may be over a communication channel such as a data network 63. Examples of a data network 63 include a local area network, a wide area network, or the internet. The system 84 may also run on the same computer through which the user engages in data communication with the system 84. The system 84 and its components 70, 76, 78 can be hardware, software or a combination of hardware and software. For example, the system 84 can include instructions on an information storage medium to cause a microprocessor to perform as described below. There is no requirement that every software component be running on the same computer. For example, the interface layer 70 may run on the user's computer and the processing layer 76 may run on another computer.

The database 78 may include a single information storage medium 80 such as a magnetic or optical disk, or several such media in data communication. There is no need for the several media to reside in one physical location; for example, the database 78 may include a storage medium at each of several research facilities in different states. There may be, but need not be, a “central” information repository 82 that duplicates the data stored on the several storage media 80.

Generally, the interface layer 70 receives data from the user 62, passes the data to a processing layer 76, which in turn interacts with the database 78. The metadata representation 44 can facilitate communication between the user 62 and the information collection/retrieval system 84 by relieving the user's computer from having to know the structure of the data element taxonomy 12 or how that structure is realized in the database 78.

In this regard, the metadata representation 44 can be used by the processing layer 76 to channel read/write requests from the user 62 about particular data elements 22 to the appropriate portions of the database 78. For example, a user 62 who wants to read a particular data element 22 that is within a family of nested categories need only provide the information collection/retrieval system 84 with the system name of the data element 22, or other information sufficient to unambiguously identify the data element 22 in the metadata representation 44. Given the system name of the data element 22, the metadata representation 44 can be used by the processing layer 76 to determine other characteristics of the data element 22, such as its location in the database hierarchy. Such an arrangement provides a degree of flexibility in implementing the information collection/retrieval system 84. For example, if the data element taxonomy 12 is reorganized and the metadata representation 44 is updated to reflect the reorganization, the user can continue to interact with the system 84 just as he did previously. In particular, the interface layer 70 remains unchanged.

The interface layer 70 and processing layer 76 may be implemented using any architecture or language capable of processing input from a user and causing subsequent access to the database 78. In some embodiments, the interface layer 70 is implemented in the Apache Struts framework, a project of the Apache Software Foundation. Information concerning Struts is available on the World Wide Web at www.apache.org or directly from the Apache Software Foundation at 1901 Munsey Drive, Forest Hill, Md. 21050-2747. Such an implementation includes a Struts controller 64 that receives communications from the user 62, for example in the form of Hypertext Transfer Protocol (“HTTP”) requests. The Struts controller 64 invokes a Struts action 66 that consults with the processing layer 76 according to the HTTP request. The interaction between the Struts controller 64 and the processing layer 76 may be implemented, for example, according to business transaction details provided in a data transfer object generated by the code generator 47a. Upon receiving a response from the processing layer 76, the Struts action 66 will serve information back to the user 62, for example by creating a Struts ActionForm or a Java Server Page (“JSP”).

In some embodiments, in response to the Struts action 66, the processing layer 76 may create a business transaction (“BTX”) 72 and send it to a business transaction performer 74. The business transaction 72 and the business transaction performer 74 are configured based on the infrastructure created by the code generator 47a, and ultimately based on the information model 10. The business transaction performer 74 interacts with the database 78 and retrieves or stores information requested by the user 62.

FIG. 7 shows another configuration for an information collection/retrieval system 84′ that allows one or more users to collect and retrieve information from a single database 78 that can be, but need not be, a component in any particular system 84′. Each information collection/retrieval system 84′ can be based on different information needs of different users 62, 62′. For example, the systems 84′ may have been generated as described above from different information structures 10, different data element taxonomies 12, or different subsets of information specifications 14 within the same data element taxonomy 12.

Other implementations are within the scope of the following claims. For example, the information structure 10 need not be limited to the context of diseases. The above description is pertinent in any context where information is collected or retrieved, such as other biological contexts (e.g., biomarkers, tissue bank operations), and other non-biological contexts such as client management in a service-related industry.

What is claimed is:

1. A method for configuring an information collection/retrieval system, the method comprising:
receiving a data file structured to describe biomedical data;
generating a first metadata representation of a first part of the data file;
generating a first configuration file based on the first metadata representation; and
configuring the information collection/retrieval system using the first configuration file.

2. The method of claim 1, wherein receiving the data file comprises receiving a spreadsheet representation of the data file.

3. The method of claim 1, wherein generating a first metadata representation includes generating a database representation of the first part of the data file, and generating the first metadata representation based on the database representation.

4. The method of claim 3, wherein generating a database representation includes expressing the database representation in a structured query language.

5. The method of claim 1, wherein generating the first metadata representation comprises expressing the first metadata representation in a markup language.

6. The method of claim 5, further comprising selecting the markup language to be extensible markup language.

7. The method of claim 1, wherein generating the first configuration file includes expressing the first configuration file in a markup language.

8. The method of claim 7, further comprising selecting the markup language to be extensible markup language.

9. The method of claim 1, further comprising generating a database schema based on the data file, and wherein configuring the information collection/retrieval system also includes applying the database schema to a database.

10. The method of claim 1, wherein configuring the information collection/retrieval system includes generating a user interface based on the data file.

11. The method of claim 1, further comprising:
generating a second metadata representation of a second part of the data file;
generating a second configuration file based on the second metadata representation;
further configuring the information collection/retrieval system using the second configuration file.

12. The method of claim 1, further comprising checking at least one of the database representation, the metadata representation, and the configuration file for errors.

13. A computer-readable medium having encoded thereon software for configuring an information collection/retrieval system, the software including instructions for causing a computer to:
receive a data file structured to describe biomedical data;
generate a first metadata representation of a first part of the data file;
generate a first configuration file based on the first metadata representation; and
configure the information collection/retrieval system using the first configuration file.

14. The medium of claim 13, wherein the instructions causing the computer to receive a data file include instructions for receiving a spreadsheet representation of the data file.

15. The medium of claim 13, wherein the software further comprises instructions for generating a first database representation of the data file, and wherein the instructions for generating the first metadata representation include generating the first metadata representation based on the first database representation.

16. The medium of claim 15, wherein instructions for generating the database representation include instructions for expressing the database representation in a structured query language.

17. The medium of claim 13, wherein the instructions include instructions for expressing the first metadata representation in a markup language.

18. The medium of claim 17, wherein the instructions include instructions for expressing the first metadata representation in extensible markup language.

19. The medium of claim 13, wherein the instructions include instructions for expressing the first configuration file in a markup language.

20. The medium of claim 19, wherein the instructions include instructions for expressing the first configuration file in extensible markup language.

21. The medium of claim 13, wherein instructions further cause the computer to generate a database schema, and the instructions for configuring the information collection/retrieval system include applying the database schema to a database.

22. The medium of claim 13, wherein the instructions further cause the computer to generate a user interface based on the data file.

23. The medium of claim 13, wherein the instructions further cause the computer to:
generate a second metadata representation of a second part of the data file;
generate a second configuration file based on the second metadata representation; and
further configure the information collection/retrieval system using the second configuration file.

24. The medium of claim 13, wherein the instructions further cause the computer to check at least one of the first metadata representation and the first configuration file for errors.

25. An information collection/retrieval system comprising:
a database having a structure based on a taxonomy file describing biomedical data;
a first interface layer generated on the basis of the taxonomy file, the first interface layer being configured to receive data from a user; and
a first processing layer in data communication with the first interface layer, the processing layer being generated based on the taxonomy file, the processing layer being configured to access the database.

26. The information collection/retrieval system of claim 25, wherein the taxonomy file comprises proper subsets that are each capable of generating an interface layer and a processing layer, wherein the first interface layer and the first processing layer are generated based on a proper subset of the taxonomy file.

27. The information collection/retrieval system of claim 26, further comprising
a second interface layer that is generated based on a second proper subset of the taxonomy file, the second interface layer for receiving commands from a second user; and
a second processing layer in data communication with the second interface layer, the second processing layer being generated based on the second proper subset of the taxonomy file, the second processing layer for accessing the database.

28. The system of claim 25, wherein the biomedical data comprises data describing three distinct disease groups.
